(19) United States
(12) Patent Application Publication
(10) Pub. No.: US 2024/0174237 A1
(43) Pub. Date: May 30, 2024

(54) METHODS AND APPARATUS FOR GEOMETRIC AND DRIVER PROFILES FOR A VEHICLE

(71) Applicant: Atlis Motor Vehicles, Inc., Tempe, AZ (US)

(72) Inventors: Mark Hanchett, Mesa, AZ (US); Matt Wilkins, Portland, OR (US); Ross Compton, Norwich (GB)

(21) Appl. No.: 18/433,263

(22) Filed: Feb. 5, 2024

(51) Int. Cl. B60W 40/09; B60R 1/26; B60R 11/04

(52) U.S. Cl. CPC B60W 40/09; B60R 1/26; B60R 11/04

(57) ABSTRACT

Geometric and driving profiles are used to set the equipment of vehicles so that the vehicle is configured and performs in a manner that is familiar to a driver to increase the safety of operation of the vehicle by the driver. Geometric and driving profiles may be managed by a server. Geometric and driving profiles may be used across a fleet of vehicles.

### CROSS REFERENCE TO RELATED APPLICATIONS

This document claims the benefit of the filing date of U.S. Provisional Patent Application 63/003,208, entitled “Methods and Apparatus for a Vehicle” to Hanchett, et al. which was filed on Mar. 31, 2020, the disclosure of which is hereby incorporated entirely herein by reference.

This application is a divisional application of the earlier U.S. Utility Patent Application to Hanchett et al. entitled “Methods and Apparatus for a Geometric and Driver Profiles for a Vehicle,” application Ser. No. 17/216,150, filed Mar. 29, 2021, now pending, the disclosure of which is hereby incorporated entirely herein by reference.

### FIELD OF INVENTION

Embodiments of the present invention relate to vehicles and in particular to setting the equipment of the vehicle.

### BACKGROUND

Vehicles may include myriad components (e.g., heating, mirrors, seats, steering wheels) that may be set (e.g., adjusted) by a driver. Each driver may have preferred settings for each component or combinations of components. Presently a vehicle may store the preferred settings for one or two people.

A fleet of vehicles used by a plurality of drivers may benefit from a server that stores, provides, and determines settings for each driver and for each vehicle in the fleet.

### SUMMARY

Geometric profiles may be used to set the equipment of the vehicle to the preferred settings and modes of operation for a driver. Driving profiles may be used to set the equipment of a vehicle to the preferred driving performance settings for a driver. Geometric profiles for a driver may be specific to a vehicle. Driving profiles for a driver may be used in a number of vehicles. Geometric profiles and driving profiles may be managed by a server. Vehicles of the fleet may communicate with the server to send and receive profiles. Using geometric and/or driving profiles increases the safety of operation of vehicles because the equipment is set in a manner that is familiar to the driver.

### BRIEF DESCRIPTION OF THE DRAWING

Embodiments of the present invention will be described with reference to the drawing, wherein like designations denote like elements, and:

FIG. 1 is a drawing of a top view of an interior of a vehicle;

FIG. 2 is a drawing of a front view of a modular dashboard of the vehicle;

FIGS. 3A-3F and 3H-3K are drawings related to driving a vehicle in reverse;

FIG. 4 is a flowchart of a method performed by a vehicle for using geometric or driver profiles;

FIG. 5 is a flowchart of a method performed by a server for managing geometric or driver profiles;

FIG. 6 is a flowchart of a method for updating a geometric profile;

FIG. 7 is a flowchart of a method for updating a driver profile; and

FIG. 8 is a flowchart of a method for determining a geometric profile.

### DETAILED DESCRIPTION

### Modular Components

The interior components of the vehicle may modular. The term “modular” means that the components used in the interior of the vehicle may be standardized units, at least in size, that may be conveniently removed and replaced without significant impact on other components. Modular components may have common characteristics, such as size, shape, mounting structures and interface with other modular components. The common characteristics between modular components may make modular components interchangeable. A system of components for an interior vehicle may include modular components fitted together to perform the functions of the vehicle.

The system of components may include components that control the operation of the vehicle (e.g., steering, brakes, accelerator, shifter, key to ignition, dashboard) may be modular components. The system of components may also be referred to as the system of modular components. The combined width of the system of modular components may be at most one half the width of the interior of the vehicle. The system of modular components may include modular components that control the operation of the vehicle. Because the system of modular components is at most one half the width of the interior the vehicle, components of the modular system may be placed on a left side of the vehicle (e.g., US configuration) or on the right side of the vehicle (e.g., UK configuration). The system of modular components may even be moved from one side of the vehicle to the other by a manufacturer, a dealer and/or a user.

The system of modular components is suitable for installation and use it different configurations and in vehicles that serve different purposes. For example, the system of modular components that may be used in a passenger vehicle, may also be used in a commercial vehicle, a farm vehicle, farm equipment or mining equipment. For example, modular components of the system may include components such as the dashboard, user interface, steering wheel, pedal assembly, guide-by-wire interface, and possibly the seats may be used in a sedan, a consumer truck, a commercial vehicle, a commercial box truck, and/or an agricultural tractor. The interior components may be used in vehicles that serve different purposes with little or no modification and little or no assembly modifications.

In an implementation, the system of modular components includes dashboard 110 includes structures for mounting and positioning user interface 112, pedal assembly 114, guide-by-wire interface 116, steering wheel 120, center screen 118, and HVAC system 132.

User interface 112 may include one or more displays to provide information to a driver. Information may include instrument information (e.g., speedometer, temperature, battery charge level, battery temperature, distance to next charge, navigation guidance). User interface 112 may include controls (e.g., buttons, levers, knobs) to receive information from the driver regarding control and/or operation (e.g., turn signal lever, windshield wiper control, side view mirror positioning, horn, cruise control, radio control, phone control, high beam, lights, emergency lights) of the vehicle. User interface 112 may include entertainment devices (e.g., radio, satellite radio), navigation devices (e.g., GPS receiver) and their associated displays.

However, in an implementation, user interface 112 is used only to display information, and in particular information related to controlling the vehicle while driving, while other information and user inputs may be seen on and/or entered into center screen 118.

User interface 112 may further include displays that provide information from a rearward-facing camera, that replaces the rearview mirror, and side-mounted cameras, that replace side-view mirrors. The displays for the rearward-facing camera and the side-mounted cameras may be positioned in front of the driver, so the driver does not need to turn their head to get information regarding the side or rear of the vehicle.

Dashboard 110 may further include center screen 118. User interface 112 may display information related to operation of the vehicle (e.g., speed, temperature, side view, rearview). User interface 112 may permit little or no user interaction. User interface 112 may present information only without receiving any driver input. Center screen 118 may display information and receive user input regarding functions that are not directly related to present operation of the vehicle. For example, center screen 118 may include a user interface for the entertainment system (e.g., radio). Center screen 118 may include a user interface for non-driving related functions of the vehicle (e.g., cabin temperature, telephone Bluetooth control, air conditioning control, configuration of user interface 112, interior lighting control, lighting control of user interface 112, distance to next charge, battery capacity, battery temperature, vehicle statistics, fuel economy, side view mirror positioning, windshield wiper control).

Information not displayed on user interface 112 may be displayed on center screen 118. Controls that receive user input that are not implemented on user interface 112, may be implemented on center screen 118. The information that is displayed on user interface 112, as opposed to on center screen 118, may be controlled by software that may be specified at manufacture, at installation, or by the driver to at least to some extent. Controls not accessed on user interface 112 may be accessed via center screen 118. The location of controls, whether user interface 112 or center screen 118 may be controlled by software and may be specified at manufacture, at installation, or by the driver to at least to some extent. Preferably, the information provided via user interface 112 is driving or driver related, while all other information may be provided in or accessed via center screen 118.

A driver will need driving and vehicle related information regardless of the type of vehicle being driven. Presenting driving information on user interface 112 makes user interface 112 suitable for most if not all vehicles. Presenting all other types of information on center screen 118 aggregates the information that may be different into a central location for ease of modifications. In an implementation, user interface 112 provides information pertinent to all types of vehicles, while software, executed at manufacture or at installation, prepares center screen 118 to present more vehicle related information. For example, user interface 112 displays vehicle speed which is needed in all vehicles. Whereas, an infotainment system may be accessible via center screen 118, but eliminated when dashboard 110 is used in a tractor.

Steering wheel 120 may include controls (e.g., buttons, levers) that allow a driver to respond to information displayed on user interface 112 or center screen 118. Preferably, the controls on steering wheel 120 relate to control needed for driving, whereas all other controls may be positioned on center screen 118. Center screen 118 may be a touch screen display, so many controls may be presented on center screen 118 for receiving input from a driver or a passenger.

Pedal assembly 114 may include a pedal for controlling acceleration/speed and a pedal for controlling deacceleration/stopping. Pedal assembly 114 may further include a pedal for setting and/or releasing an emergency brake, a control (e.g., button) the high beam of the headlight, a cover release for recharging and a hood release. Pedal assembly 114 is a control-by-wire, herein also referred to as guide-by-wire or drive-by-wire, assembly. Pedal assembly 114 does not control by mechanical means (e.g., cables, levers, gears). The pedals or other controls (e.g., knobs, buttons) of pedal assembly 114 include transducers that transform movement and/or operation of the pedals or the controls into an electrical signal. The electrical signal is transmitted (e.g., by wire, wirelessly) to the device being controlled (e.g., motor controller, brake controller, steering controller, light controller, hood latch) and converted, if necessary, from an electrical signal into mechanical movement that controls the device. Pedal assembly 114 may either send mechanical information to guide-by-wire interface 116 for conversion to electrical signals and transmission. Guide-by-wire interface 116 may be omitted and pedal assembly 114 may convert from mechanical to electrical and transmit the signals.

Like pedal assembly 114, steering wheel 120 does not control the direction of travel of the vehicle by mechanical means. Steering wheel 120 is a guide-by-wire assembly. As a driver turns steering wheel 120, steering wheel 120 either send mechanical information to guide-by-wire interface 116 for conversion to electrical signals or guide-by-wire interface 116 may be omitted and steering wheel 120 converts movement (e.g., operation) of the steering wheel 120 into electrical signals that are transmitted to the steering controller.

Guide-by-wire interface 116 may be used to consolidate conversion and or transmission of guide-by-wire signals. Guide-by-wire interface 116 may receive mechanical information from an assembly (e.g., pedal assembly 114, steering wheel 120), convert mechanical information into electrical signals, and transmit the signals to the appropriate destination (e.g., the wheels, the breaks, the lights). Guide-by-wire interface 116 may receive electrical signals from various assemblies, consolidate the electrical signals, encode the electrical signals possibly to include redundancy for reliability, and transmit the signals to the appropriate destination. Whether the guide-by-wire function is consolidated in an assembly such as guide-by-wire interface 116 or is performed by the individual assemblies (e.g., pedal assembly 114, steering wheel 120), the vehicle uses guide-by-wire principles and technology for controlling the vehicle.

Dashboard 110, user interface 112, pedal assembly 114, steering wheel 120, and optionally guide-by-wire interface 116 have a modular design that allows easy assembly with each other and integration into vehicles of different types. These components are modular for use in different situations and vehicles without modification. Seats 130 and 132 may also be modular in that they may be installed in a variety of different types of vehicles without modification.

Dashboard 110 provides structure for mounting steering wheel 120, pedal assembly 114, user interface 112 and center screen 118. Dashboard 110 and the components mounted thereto (e.g., pedal assembly 114, drive-by-wire interface 116, user interface 112, steering wheel 120, center screen 118) do not extend the entire width of the interior of the vehicle. Dashboard 110 is at most half the width of the interior the vehicle. Because the width of dashboard 110 is at most half the width of the interior vehicle, dashboard 110 may be positioned on either side of the vehicle.

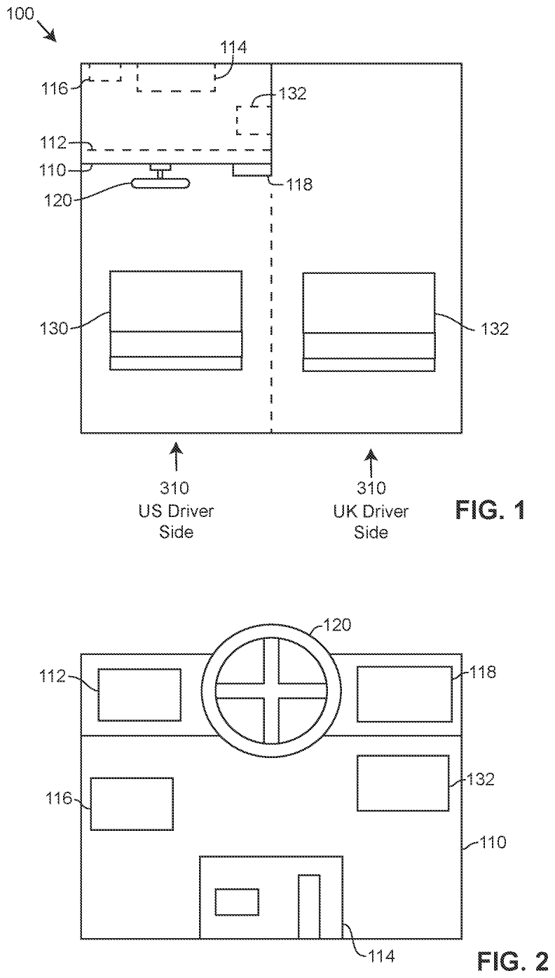

Because dashboard 110 is at most half the width of the interior of the vehicle, dashboard 110 may be installed on a left side of the vehicle for vehicles destine for use in countries that drive on the right side of the road, such as the US. Dashboard 110 may be installed on a right side for vehicles destine for use in countries that drive on the left side of the road, such as in the UK. Components mounted to dashboard 110 may move with dashboard 110 as it is positioned on one side to the other. Dashboard 110 is installed on US driver-side 140 in FIG. 1. Because dashboard 110 is designed as a modular unit, dashboard 110, and its associated components, may just as easily be installed on UK driver-side 142.

In another implementation, dashboard 110 is mounted on a rail system that facilitates movement of dashboard 110 from US driver-side 140 to UK driver-side 142. The rail allows vehicles to be configured for the country of destination after manufacturing process is complete. In fact, the rail system enables the vehicle to be configured for the destination country after arrival in the country. For example, vehicles manufactured in the US may position the dashboard 110 on US driver-side 140. A US configured vehicle may be shipped to the UK. A dealer or mechanic in the UK may slide the dashboard 110 along the rail from US driver-side 140 to UK driver-side 142 to adapt the vehicle to be driven in the UK. Repositioning dashboard 110, and the associated components, using a rail system would take minutes rather than hours or days. Because steering wheel 120 and pedal assembly 114 are drive-by-wire devices, repositioning dashboard 110 does not require any rewiring or mechanical alterations to the vehicle.

Because dashboard 110 does not extend the entire width of the vehicle, the dashboard 110 is not positioned in front of the passenger, thereby giving the passenger more room. Further, the passenger-side front airbag may possibly be eliminated because there is no dashboard into which the passenger might collide. Eliminating the dashboard in front of the passenger would not eliminate the need or desirability of side airbags.

The structures of the dashboard 110 may include a frame and one or more panels. The frame establishes a shape of the dashboard 110. The one or more panels may couple to the frame. Modular components (e.g., steering will, pedal assembly, user assembly, center screen, guide-by-wire interface) may couple to the frame and/or the one or more panels. The frame may contact the rail. The frame may move along the rail to position the dashboard 110. The frame may couple to the rail to fix (e.g., secure) the position of the dashboard 110 with respect to the rail and the interior of the vehicle.

The components identified in FIG. 1 may be used in any type of vehicle without changing the size of the component. Components may be repositioned with respect to dashboard 110, but the size of the component, the interface to the other components, and their function does not change. Depending on the type of vehicle in which the components are installed, the information displayed on user interface 112 and center screen 118 may be changed by alteration of software or recompiling of software. The controls implemented on user interface 112 and center screen 118 may also be changed by alteration of software or recompiling of software. The change in software may be adapted to the type of vehicle into which components are being installed. The components, hardware interfaces and mechanical interfaces of the components do not change for installation in a different vehicle, however the software for that type of vehicle may alter their function.

Software may also be used to alter the information displayed in the controls provided by user interface 112 so that center screen 118 may be eliminated. For example, a tractor may have fewer functions related to driving the tractor, so the functions needed for the tractor may be programmed to be displayed on user interface 112 and center screen 118 eliminated. As discussed above, the software that drives and controls the components shown in FIG. 1 and discussed above may be different for different types of vehicles.

### Driving in Reverse

The front and rear wheel (e.g., drive) modules (e.g., wheels, motors, turning control) of the vehicle are the same. A wheel module may operate in various modes. Modes of operation of wheel module may include a powered mode in which the wheels rotate under power to provide movement of the vehicle. While in the powered mode, the wheels (e.g., tires) of a wheel module may rotate in either direction (e.g., forward, backward). In the freewheeling mode, the wheels are free to rotate responsive to movement of the vehicle, but do not rotate under power to move the vehicle. In the steering mode, the wheels may be steered (e.g., turned) to the left or to the right to steer the vehicle to the left or to the right as opposed traveling only in a straight line. In the locked mode, the wheels are locked (e.g., fixed) so they cannot steer to the left or to the right but are positioned in a straight line with the vehicle.

Each wheel module may work in a single mode or combination of modes. For example, the wheel modules positioned in a rear of the vehicle may operate in the locked and powered modes to provide rear wheel drive to the vehicle. In another example, the wheel modules positioned in the rear of the vehicle may operate in the locked and freewheeling modes, while the wheel modules in the front of the vehicle operate in the powered and steering modes so the vehicle may operate as a front-wheel-drive vehicle.

As discussed above, the vehicle includes one or more rearward-facing cameras (e.g., video cameras). The cameras in combination with the wheel modules may enable a driver to drive backwards in a manner that is as natural as driving forward. The vehicle includes one or more displays in the user interface or the center screen. The views from the rear of the vehicle may be sent to the user interface or the center screen for viewing by the driver. The wheel modules at the rear of the vehicle may be put in the powering and steering modes; however, the rear wheel modules may be instructed to rotate in the reverse direction so as to pull the vehicle backwards (e.g., rear of vehicle facing direction of travel). The wheel modules at the front of the vehicle may be put into the locked and freewheeling modes. With the wheel modules in these modes, the driver may monitor the user interface and the center screen to see the road behind the vehicle. Rotating the steering wheel clockwise (e.g., to the right) causes the vehicle to turn to the right in the direction of travel (e.g., backwards), just as it would if it were traveling forward. Rotating the steering wheel counterclockwise (e.g., to the left) causes the vehicle to turn to the left in the direction of travel (e.g., backwards), just as it would if it were travelling forward.

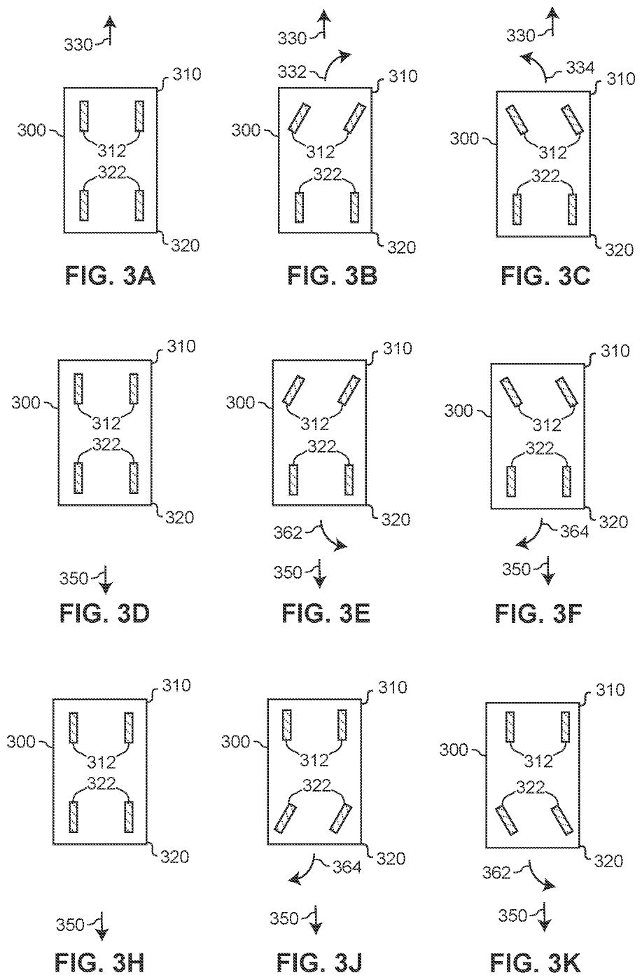

The effect on the direction of the turn in the direction of travel with the wheel modules in different modes is best shown in FIGS. 3A-3F and 3H-3K. In the figures, the front 310 and the rear 320 of vehicle 300 with respect to the front tires 312 and the rear tires 322. Each tire is associated with a tire module (not shown). In FIGS. 3A-3C, the direction of travel is the forward direction of travel 330. In the forward direction, the front 310 of the vehicle 300 leads. In FIGS. 3A-3C, the rear wheel modules are in the locked and powered modes in which the rear tires 322 rotate to move the vehicle 300 in the forward direction of travel 330. In FIG. 3B, the driver turns the steering wheel clockwise, so the front tires 312 turn to the right with respect to the direction of travel 330 and, as a result, the vehicle turns in the right 332 with respect to the direction of travel 330. In FIG. 3C, the driver turns to steering wheel counterclockwise, so the front tires turn to the left with respect to the direction of travel and, as a result, the vehicle turns in the left 334 with respect to the direction of travel 330.

In FIGS. 3D-3F, the wheel modules operate in the same modes as in FIGS. 3A—3C. In FIG. 3E, the driver turns the steering wheel clockwise, so the front tires 312 turn to the right with respect to the direction of travel 350; however, since the tires that have turned (e.g., 312) are not the tires that are leading in the direction of travel (e.g., rear tires 322 lead in the direction of travel), vehicle 300 turns to the left 362, which is left with respect to the direction of travel. In FIG. 3F, the driver turns the steering wheel counterclockwise, so front tires 312 turn to the left with respect to the direction of travel. As above, because the tires which are turned are not leading, vehicle 300 turns to the right 364, which is right with respect to the direction of travel.

So, the direction of the turn with respect to the direction of travel in FIGS. 3E and 3F is the opposite of the direction of turn with respect to the direction of travel in FIGS. 3B and 3C respectively.

In the vehicle 300 shown in FIGS. 3H, 3J and 3K has the front tires 312 in the locked and free wheel mode, while the rear tires 322 are in the powered and steering mode. The rear tires 322 rotate in the direction to propel the vehicle 300 in the direction of travel 350. In FIG. 3J, the driver turns the steering wheel clockwise and the rear tires 322, which are the leading tires with respect to the direction of travel 350, turn to the right with respect to the direction of travel. As a result, the vehicle 300 turns to the right 364 with respect to the direction of travel. In FIG. 3K, the driver turns the steering wheel counterclockwise and the rear tires 322 turn to the left with respect to the direction of travel. As a result, the vehicle 300 turns to the left 362 with respect to the direction of travel 350.

In FIGS. 3B-3C, turning the steering wheel clockwise results in the vehicle 300 turning to the right 332 with respect to the direction of travel; whereas, turning the steering wheel counterclockwise result in the vehicle 300 turning to the left 334 with respect to the direction of travel 330.

In FIGS. 3E-3F, turning the steering wheel clockwise result in the vehicle 300 turning to the left 362 with respect to the direction of travel 350. Turning the steering wheel counterclockwise results in the vehicle 300 turning to the right 364 with respect to the direction of travel 350.

In FIGS. 3J and 3K, turning the steering wheel clockwise results in the vehicle turning to the right 364 with respect to the direction of travel 350. Turning the steering wheel counterclockwise results in the vehicle 300 turning to the left 362 with respect to the direction of travel 350.

When the vehicle is configured as it is in FIGS. 3A-3C and 3J-3J and 3K, turning the steering wheel clockwise results in the vehicle 300 turning to the right 332/364 with respect to the direction of travel 330/350. Turning the steering wheel counterclockwise results in the vehicle 300 turning to the left 334/362 with respect to the direction of travel 330/350. Because the direction of the turn is the same for the direction of turning the steering wheel, a driver is accustomed to the vehicle's response, so driving the vehicle backwards with vehicle configured as described for FIGS. 3H-3J and 3K is easy for the driver to do. Further, because the rear tires 322 are the leading tires in FIGS. 3H-3J and 3K, the turning radius of the vehicle is similar to the turning radius of the vehicle of FIGS. 3A-3C.

The turning direction with respect to direction of travel for FIGS. 3D-3F could be reversed by reversing the turning direction of the front tires 312. If the front tires 312 turned to the left responsive to a clockwise turn of the steering wheel, the vehicle 300 would turn to the right with respect to the direction of travel. If the front tires 312 turn to the right responsive to a counterclockwise turn the steering wheel, the vehicle 300 would turn to the left with respect to the direction of travel. Even though the direction of the turn would correspond to the direction of turning the steering wheel as in FIGS. 3A-3C, the vehicle response would be different because non-lead tires are turning instead of leading tires, so the turning radius would be significantly smaller (e.g., tighter).

The tire module modes described for FIGS. 3H-3J and 3K provide a similar response with respect to the direction of travel as the operation of vehicle 300 in FIGS. 3A-3C, so the user may look at the displays (e.g., user interface 112, center screen 118) for the rearward facing cameras and drive the vehicle in reverse as though they were driving it in the forward direction. Driving in reverse may be simple and intuitive.

### Tractor

The use of interior components in a tractor has been discussed above. However, there other aspects of an electric tractor that are distinct from both electric vehicles and conventional gas-powered or diesel-powered tractors. Because tractors generally do not need to drive the distances required by vehicles, the battery pack needed to power the tractor may be smaller than the battery pack needed to power a vehicle. As a result, the front portion of a tractor where the gas or diesel engine generally is positioned maybe vacant. On an electric tractor, the front portion of the tractor may remain enclosed and may be used to store equipment or to haul equipment to the field. Doors on the side of the enclosure may protect equipment from the elements and provide access to the equipment while working.

The front portion discussed above may also be used to house extra batteries if extra energy is needed to perform tasks. In the event that the front portion of the tractor is used to store batteries, the batteries may be mounted on a sliding tray the slides forward, or sideways, to access the batteries, install the batteries, or remove the batteries. Using the front portion to hold additional batteries and the ability to remove those batteries, allows an operator to have two sets of front batteries so that when one is expended, the other may be inserted, so the operator can continue working. In general, batteries into the front portion may be used similarly to a gas can to enable extended range or extended time of operation.

### Interior Lighting

Lights encircle the ceiling of the interior of the vehicle around the headliner. When the lights are turned on, the ring of lights around the ceiling of the vehicle light up. Sections of the light may be turned on or turned off by a person positioned in that section of the vehicle. For example, a person sitting in the rear passenger seat could press a button and the portion of the lights that encircles the ceiling over the rear passenger seat would illuminate. Lights around the entirety of the ceiling provides much more interior light than lights that are positioned only at specific locations in the interior. The beams of lights may be directed (e.g., pointed) away from the driver and/or the windshield so as to not interfere with the driver or the operation of the vehicle.

### Air Delivery

A duct (e.g., pipes) may also be positioned around the interior of the vehicle near the ceiling that permits the delivery of cold or hot air to the interior. The duct around the ceiling of the vehicle would include openings that heat or cool the interior environment as a whole rather than directing air to an individual.

### Seating

A conventional seat for a vehicle includes a metal frame, foam positioned in and around the frame to provide comfort, and a cover over the frame and foam. A seat of a new design will likely include a metal frame, for safety purposes, and possibly foam for padding. However, the cover, and possibly some or all of the padding, may be knit using a continuous knitting process that produces goods with a single seam (e.g., nike flyknit shoes). The knitting process is computer-controlled to provide greater thickness (e.g., two or more layers) where needed and thinner material (e.g., one layer) where thickness or padding is not needed. The knitting process may knit multiple layers into the portions the cover where the cover supports or contacts the user's body to provide padding for comfort and protection. The knitting process may knit a single layer into the portions of the cover where the user's body does not contact and/or where padding is not needed. The knitting process may knit multiple layers into portions of the cover that experience high wear.

Manufacturing seats using this knitting process allows material to be added to areas where wear and tear is high.

After knitting, the cover may be placed around the metal frame. The cover may be stretched to fit around a metal frame or a metal frame may be constructed inside the seat near an opening and moved into position inside the cover.

Knitting the seats from a single material makes the seats easier to recycle because different materials do not need to be separated from each other prior to recycling.

### Frunk

In conventional gas or diesel vehicles, the engine that drives the vehicle is located, generally, in the front of the vehicle. In an electric vehicle, the electric motors that drive the wheels are located proximate to the axles or proximate to the wheels. In an electric vehicle, the batteries may be positioned below the cabin and/or inside the frame. The position of the electric motors and the batteries leaves the front portion of the electric vehicle vacant. The front portion of an electric vehicle may be designed to store cargo. The front portion may be enclosed to protect cargo from the elements and may have one or more doors to provide access.

### Geometric and Driving Profiles

Information may be transferred from one vehicle to another vehicle. Information may be transferred from a vehicle of one type to a vehicle (e.g., sedan, truck, industrial truck, tractor) of a vehicle of another type. Information may be transferred via a server. A server may receive, store, and provide information to vehicles of a fleet of vehicles. A fleet of vehicles may include a variety of different types of vehicles. Information regarding the vehicles of a fleet may be stored on a server. Information regarding the authorized drivers of the vehicles of a fleet may also be stored on the server. The server may store information regarding which authorized driver is assigned to operate which vehicle in the fleet. An authorized driver of a vehicle of the fleet be personally identifiable. An identity of an authorized driver of a vehicle of the fleet may be verifiable (e.g., authenticated). A driver may carry identification (e.g., mobile application on phone, swipe card, magnetic card) that verifies the identity of the driver. Biometric information may be used to identify an authorized driver. A vehicle may receive the driver's identity information. A vehicle may send the drivers identity information to the server for verification (e.g., authentication). Verifying the identity of a driver may confirm the driver's authorization to operate a vehicle of the fleet. Verifying the identity of a driver may allow the server to determine whether the driver has been assigned to the vehicle that provided the driver's identifying information.

Information stored by a server may also include a geometric profile and/or a driving profile of the driver. A geometric profile includes information regarding the driver's preferred physical settings for a particular vehicle. The physical settings stored in a geometric profile relate to the physical measurements (e.g., characteristics) and equipment of the particular vehicle. A geometric profile may be created and stored for a driver for each vehicle respectively of a fleet. In other words, a server may store a geometric profile for a driver for each vehicle in the fleet. In the case where the vehicles in the fleet of a certain type have the same physical dimensions, a geometric profile for a driver may be stored for each vehicle type. In the case where vehicles of the same type have different physical dimensions, a geometric profile for a driver may be stored for each individual vehicle even though they are the same type.

When a driver enters a vehicle that they have never used before or has been used by another person, the driver takes the time to adjust the seat (e.g., distance to steering wheel, height from the floor pan, angle of the seat back, seat stiffness, seat temperature, headrest position, heat on, heat off, heat setting), the steering wheel (e.g., distance from dashboard, tilt, heat on, heat off), the HVAC (e.g., temperature settings, duct outlet positions, backseat control enabled, backseat control disabled, fan speed, AC on, AC off, defrost on, defrost off, rear defrost on, rear defrost off), the mirrors (e.g., mirror position, auto dimming), the windows (e.g., closed, partially open), the headlights and exterior lights (e.g., on, off, parking, driving mode, fog), the windshield wipers (e.g., interval setting), odometers (e.g., shown on dashboard, hidden from dashboard, trip odometers shown, trip odometers hidden, trip odometers reset, mph, kph, analog output, digital output), the speedometer (e.g., metric, Imperial), the entertainment system (e.g., radio station, satellite station, volume, fade, balance, bass setting, treble setting, midrange setting, passenger video enabled, rear video enabled, headrest speakers on, headrest speakers off, automatic noise compensation on, automatic noise compensation off), the communication system (e.g., hands-free cell phone on, hands-free cell phone off), the wireless system (e.g., in-car Internet on, in-car Internet off), and the interior lights (e.g., on, off, dimmed, backlights, map light, passenger light, dashboard light brightness, center screen brightness, ceiling light on door open on, ceiling light on door open off). Some vehicles may have additional systems that may be set to the preference of the driver.

Setting equipment in a vehicle means setting the position, status, range, operating mode, and/or the manner in which the equipment of the vehicle operates. Generally, once equipment in a vehicle is set, it remains in that position, that status, that range and/or that operating mode until it is adjusted by a user or is set again in accordance with a geometric profile. Setting equipment in a vehicle refers to physically establishing how the equipment operates. Physically establishing how equipment operates may be accomplished manually by a driver, using electronic and/or electromechanical devices and/or automatically via electronic or electromechanical devices.

A geometric profile may record information regarding the above vehicle systems and the settings and/or positions selected by the driver. A geometric profile may be created for each type of car (e.g., sedan, van, sports car, truck).

The information in a geometric profile may be used to set (e.g., initialize, position) the equipment that would be manually set by a driver prior to driving. Using a geometric profile for the driver for each vehicle means that the equipment of the vehicle will be set to the driver's preferences. Setting the equipment to the driver's preferences establishes a familiar environment for the driver for the operation of the vehicle thereby increasing the safety of operating the vehicle. Further using a geometric profile for the driver to set the equipment of a vehicle saves time and ensures consistency of setting the equipment in any vehicle of the fleet.

A server may also store information related to the physical characteristics of the driver. Information related to the physical characteristics of the driver may be stored in each geometric profile for the driver for each vehicle or the information related to the physical characteristics of the driver may be stored in a separate file that contains only the driver's physical characteristics. The physical characteristics of the driver may include weight, height, arm length, leg length (e.g., inseam length), ratio of leg length to the total height, length of torso, ratio of torso to the total height, length of neck, vision acuity (e.g., nearsighted, farsighted, requires bifocals), seated height to top of head, seated height to eyes, seated distance to shoulders, shoulder width, hand with, finger length, use of glasses or contact lenses, any other measurement of the physical characteristics of the driver while the driver is in any position (e.g., seated, standing, leaning forward, head turned, legs extended, arms extended), and any other information regarding the physical characteristics of the driver.

The physical dimensions (e.g., measurements, characteristics) of a vehicle may include internal width of cabin, seat placement in cabin, range of seat adjustments, range of steering wheel adjustments, angle from the seat to the instrument panel on the dashboard, angle from the seat to rearview mirrors, angle from the seat to the side view mirrors, distance between steering wheel and entertainment center or other controls, and so forth.

The physical dimensions of a vehicle further include distances and angles between components of the vehicle (e.g., middle of seat to steering wheel, back of seat to steering wheel, floor pan to top of seat, middle of seat to HVAC controls, back of seat to petals, front of seat to petals, angle from top of seat to instrument control panel on dashboard, angle from side of seat to HVAC controls, distance to a heat duct, and so forth). The distances and angles may be measured from any component inside or outside of the vehicle to any other component. If a component is adjustable, the physical measurements of the vehicle may include the range of adjustment and distances and/or angles to other components with respect to the range of adjustment (e.g., distance of travel from forward position to rear position of the seat, angle of rotation of the heat duct, range of tilt of steering wheel, range of tilt of seat back, angle of top of seat back to dashboard with respect to angle of tilt of seat back, and so forth).

Because a geometric profile is related to the physical dimensions of a particular vehicle, each vehicle may have a different geometric profile for the same driver, even vehicles of the same type as discussed above. A type of vehicle may share the same geometric profile for a driver, but only if the physical dimensions of all of the vehicles for that vehicle type are the same. A geometric profile is referred to as a geometric profile for a driver for a vehicle; which means that a geometric profile is particular (e.g., specific) to a driver and a vehicle.

The information in a geometric profile may be related to the physical characteristics of the driver and the physical dimensions of a particular vehicle. The setting for the seat may relate to the distance between the edge of the seat and the HVAC controls and the length of the driver's arm when determining the position (e.g., forwards, backwards), tilt, and height of the seat. The distance between the center of the seat and the turn indicator controls may relate to the length of the driver's arms. The angle from top of the seat to the instrument control panel on the dashboard may take into account the seated height of the driver, and in particular the position of the driver's eyes, with respect to the position of the steering wheel in front of the dashboard and instrument control panel. The angle from the seat to a side rearview mirrors and/or the rearview mirror may take into account the seated height of the driver, and in particular the position of the driver's eyes, with respect to the side rearview mirrors and/or the rearview mirror.

The information in the geometric profile may be used to set the equipment in a vehicle for the driver so that the driver is best positioned to safely and effectively operate the vehicle. Any physical characteristic of the driver may be compared to or considered with respect to any physical dimension of the vehicle or equipment adjustments ranges for determining the best settings for the equipment for the driver for that vehicle.

A vehicle may further permit a driver to set the systems of the vehicle for driving (e.g., vehicle performance) preferences. Driving preferences may include acceleration, ride responsiveness, fuel economy, regenerative braking and deacceleration. Acceleration refers to how aggressively the vehicle accelerates responsive to the accelerator pedal. Acceleration may range from high acceleration (e.g., high-G, neck-snapping) to medium acceleration (e.g., mild-G) to slow acceleration (e.g., gentle, easy, low-G). Ride responsiveness refers to how the steering and/or suspension of the vehicle responds to the road and to the driver via the brakes, the accelerator, and the steering wheel. Some vehicles permit the stiffness the suspension system (e.g., shocks) to be set by a driver. A stiff setting refers to a highly responsive vehicle in which there is little slack in the steering wheel and the vehicle responds quickly and nimbly to the control of the driver. At a low responsive setting, there may be slack in the operation of the steering wheel and the response of the shocks to bumps may be described as smooth, gentle or mushy. Fuel economy is related to acceleration, operation of an automatic transmission and the amount of fuel the vehicle uses for driving per mile. In an economy mode, acceleration is limited to save on fuel and the transmission shifts between gears at lower RPMs. In a performance setting, acceleration is higher and the automatic transmission shifts at higher RPMs to provide greater power and higher acceleration in each gear range. Deceleration refers to the amount of force required by the user on the brake pedal to accomplish a particular level of deceleration. A high deceleration means that a small tap on the brakes by the user results in deceleration and possibly high deceleration (e.g., touchy brakes, highly responsive brakes). In a low deceleration mode, the user must move the brake pedal a greater distance in order to start and/or increase the level of deceleration. In a low deceleration mode, more force may be required on the brake pedal to control and/or increase the deceleration of the vehicle. In the low deceleration mode, the brake pedal may be referred to as mushy or less responsive.

The information in a driving profile is related to the driving performance of any vehicle of a fleet. The information from a driving profile may be used to set any equipment included in a particular vehicle that affects the driving performance of the vehicle. Because driving performance is not related to the physical measurements of the vehicle, except possibly weight, one driving profile may be used to set the equipment of many vehicles of various types in a fleet. As the weight of the vehicles increase, however there may need to be a driving profile for vehicles under a certain gross weight and another driving profile for vehicles over a certain gross weight.

Using a driving profile to set the driving performance for a driver to be consistent among vehicles of a fleet increases safety. By setting the driving performance of different vehicles to be similar to the performance characteristics that the driver is accustomed to increases safety by making the operation of one vehicle similar to the operation of another vehicle. Setting the performance of different vehicles so that they perform similarly, and in a manner to which the drivers accustomed, eliminate surprises and operational differences between vehicles thereby presenting a consistent driving environment to the driver regardless of vehicle. Familiarity and consistency of driving performance increases the safety of operation of the vehicle for the driver.

A vehicle may further monitor the driving habits of a driver to determine the performance preferences of the driver. A vehicle may store observed performance behavior in the driving profile. Observed behavior may be compared to driver selected settings to determine whether the behavior is consistent with the driver selected settings over a number of vehicles. Driver selected settings that appear to be inconsistent with driver behavior in a number of vehicles and/or types of vehicles may be identified to a driver. A driver may retain the driver identified preference or may select the behavior identified preference for a driving profile. Inconsistencies between driver behavior and driver selected settings for vehicle performance may be an indication that additional training is needed for the driver for particular vehicles or particular vehicle types.

A server may store the geometric profiles and driving profile for each authorized driver of the fleet. A server may also store the physical dimensions of each vehicle in the fleet. The server may store a geometric profile for each driver for each vehicle respectively in the fleet. A server may store information related to the physical characteristics of each driver.

When the driver enters a vehicle of the fleet, the driver may identify himself/herself to the vehicle (e.g., ID badge, biometric). In turn, the vehicle may receive the geometric and/or driving profiles of the driver from the server. The vehicle may use the geometric and/or driving profiles of the driver to set the equipment of the vehicle to suit the preferences of the driver as specified in the geometric and/or driving profiles.

The server and the vehicles of the fleet may communicate with each other in any manner, using any communication link and any communication protocol. The server may store the geometric profiles, the driving profiles, and the driver characteristic files in any format and on any type of file system. The server may store and retrieve files in any manner. A server and/or a vehicle may convert one file type into another file type.

When a driver is assigned to operate a vehicle in the fleet that the driver has never used before, no geometric profile will exist for that driver for that vehicle. When a driver identifies himself/herself to the new vehicle, the server may determine (e.g., calculate, configure) a geometric profile for the driver for the new vehicle. The geometric profile determined by the server may be sent to the new vehicle and the equipment of the new vehicle set in accordance with the geometric profile.

For example, assume that the driver has used a particular sedan before from the fleet. While driving the sedan, the driver adjusted the equipment of the sedan to suit his/her likings. The settings (e.g., positions) of the equipment in the sedan were recorded and stored on a server as a geometric profile for the driver for the sedan. Each time the driver operates that sedan, the server provides the geometric profile for that driver for that sedan and the sedan sets the equipment in accordance with the geometric profile.

When the driver enters a different vehicle, say a truck, the server may not have a geometric profile for the driver for that truck, because the physical dimensions of the truck are different from those of the sedan. In this situation, the server may use the driver's geometric profile from the sedan, the physical dimensions of the sedan, the physical characteristics of the driver, and the physical dimensions of the truck to determine a preliminary geometric profile for the driver for use with the truck.

For example, the physical dimensions of the sedan may be compared to the physical dimensions of the truck. The ranges of equipment adjustments in the sedan may be compared to the ranges of equipment adjustment in the truck. The drivers preferred settings for the sedan may be related to the physical dimensions and/or ranges of the sedan and the same relationship may be calculated with respect to the physical dimensions and/or ranges of the truck. The physical characteristics of the driver may further be used with respect to the physical dimensions of the truck to determine the various settings for the equipment in the truck. Distances and/or angles as recorded in the geometric profile for the sedan with reference to the physical measurements of the sedan and the physical characteristics of the driver, may be used to determine the distances and/or angles with reference to the physical dimensions of the truck. The physical characteristics of the driver may also be considered with respect to the physical dimensions of the truck. The equipment settings determined for the driver with respect to the truck may be stored in a geometric profile for the driver for the truck.

For example, the distance of the driver seat away from the steering wheel or the pedals, as set by the driver in the sedan with respect to the length of the driver's legs, may be used to determine a distance of the driver seat away from the steering wheel or the pedals in the truck. A height of the seat from the floor as set by the driver in the sedan may be used to determine the preliminary height setting of the seat in the truck. The physical characteristics of the driver and the range of adjustment of the seat height in the sedan and the truck may further be taken into consideration while determining the preliminary height setting of the seat in the truck. As information from the geometric profile for the sedan is considered with respect to the measurements of the sedan and the physical characteristics of the driver, the physical dimensions of the sedan may be compared to the physical dimensions of the truck to determine the settings stored in the geometric profile for the driver for the truck. The driver's preferences for the sedan may be converted to a ratio, ranges, and/or angles for determining the settings of the equipment in the truck.

The calculations used to determine settings for equipment in the truck may involve a variety of physical dimensions, of the sedan and/or the truck, the settings in the geometric profile for the sedan, and the physical characteristics of the driver. For example, the calculation of a distance of the seat from the steering wheel or the pedals for the truck may involve a combination of the distance of the seat to the steering wheel or the pedals, the height of the seat above the floor, and the tilt of the seat in the sedan, and the depth of the seat of the sedan. The measurements of the driver, the vehicles, and the preferences of the driver in one vehicle may be used to determine the geometric profile for the new vehicle (e.g., truck). In determining the equipment settings to be stored in the geometric profile for the new vehicle, the server may also determine whether the settings permit the driver to see the instruments on the dashboard, the side view mirrors, the rearview reader, and/or the blind spot of the vehicle.

The geometric profile determined by the server for the truck may be sent to the truck and the equipment of the truck set in accordance with this calculated (e.g., estimated) geometric profile. Once the driver enters the truck, any changes the driver may make to the equipment of the truck may be recorded by the vehicle as the driver's geometric preferences for the truck. If the driver makes no changes to the truck, the server records the calculated geometric profile as the driver's geometric profile for the truck. Geometric profiles from one or more vehicles, along with the physical measurements of the vehicles and the physical characteristics of the driver, may be used to determine a geometric profile for any vehicle that the driver has not yet operated.

Geometric profiles for the same driver for different vehicles may be compared to detect inconsistencies in settings or possibly settings that make it difficult for the driver to operate the vehicle. For example, some settings may make it more difficult for the driver to see through the side view mirrors.

In estimating geometric preferences for a new driver for a particular vehicle, the server may compare the new driver's physical characteristics to the physical characteristics of other authorized drivers for the same vehicle. The server may use some or all of the geometric preferences of physically similar drivers to calculate a preliminary geometric profile for a new driver for a particular vehicle.

The driving profile of a driver may also be used to set the equipment in a new vehicle so that the driver experiences a similar performance in the new vehicle. The driving profile of a driver may be transferred from one vehicle to another to make adjustments in accordance with the equipment of the vehicle.

Identifying the driver, downloading profiles, and setting (e.g., adjusting) the equipment of a vehicle does not delay the driver's use of the vehicle. A driver may be identified, the profiles downloaded from the server, and the vehicle adjusted in the brief time between entering the vehicle and wanting to drive the vehicle.

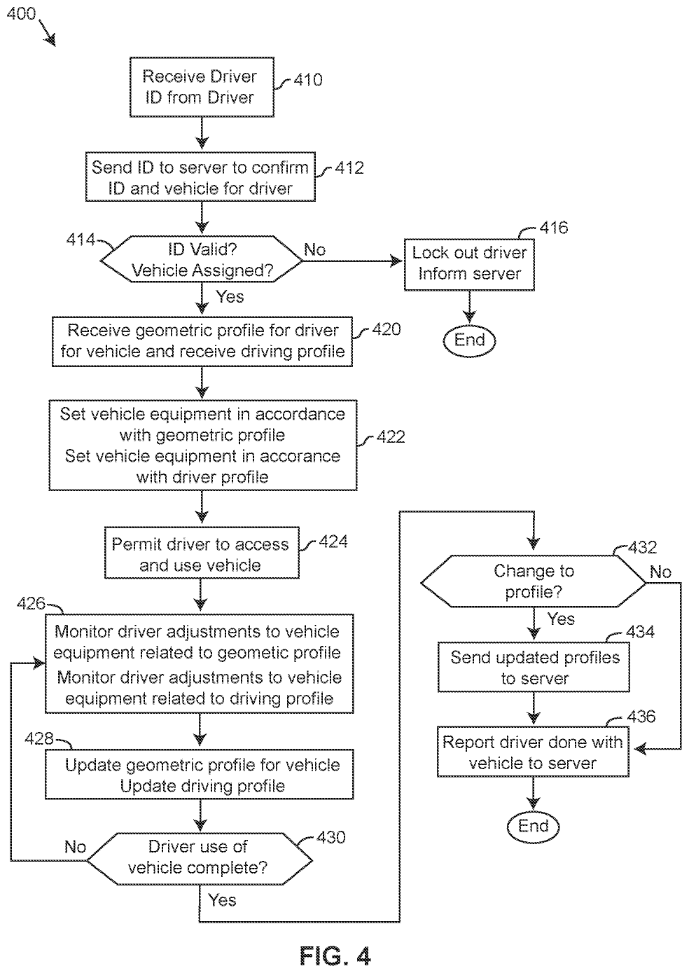

Method 400, shown in FIG. 4, is an example of a method performed by a vehicle for receiving a geometric profile and/or a driving profile and setting the equipment of the vehicle in accordance with the received profiles. Method 400 includes receive ID 410, confirm 412, valid 414, lock 416, received profiles 420, set 422, access 424, monitor 426, update 428, completed 430, changes 432, send 434 and report 436.

In receive ID 410, the vehicle receives credentials from the driver that establish the driver's identity. The credentials may be presented to the vehicle in any form. Credentials may include a badge with a magnetic strip, a badge with an embedded RFID chip, a smart phone with stored identity information, and/or biometric information (e.g., fingerprint, iris scan) from the body of the user. The vehicle receives the information regarding the driver's identity.

In confirm 412, the vehicle sends the drivers credentials to the server for confirmation (e.g., authentication). The vehicle further sends information identifying the vehicle to the server, so the server knows that the driver's credentials are being associated with the vehicle or that the driver is attempting to access the vehicle. The vehicle may send the driver's credentials and the vehicle information to the server in any manner using a wired or wireless communication link. In response to the driver's credentials and the vehicle information, the server sends information to the vehicle to either confirm or deny use of the vehicle by the driver.

In valid 414, in response receiving the information from the server in confirm 412, the vehicle determines whether the server validated the driver's credentials and use of the vehicle by the driver. If the server did not validate the driver's credentials or did not authorized the driver to operate the vehicle, control passes from valid 414 to lock 416. If the server validated the driver's credentials as being authentic and authorized the driver to operate the vehicle, control passes from valid 414 to receive profiles 420.

In lock 416, the vehicle refuses to allow the driver access to the vehicle because either the drivers credentials were not authentic or the driver is not authorized to use the vehicle. The vehicle acknowledges with the server (e.g., sends acknowledgment, sends a notice) that the driver has been locked out of the vehicle. From lock 416, control passes to end.

In receive profiles 420, the vehicle receives, from the server, the geometric profile for the driver for that vehicle and the driving profile for the driver. As discussed above, information may be communicated between the server and the vehicle in any manner.

In set 422, the vehicle uses the geometric profile for the driver to set the equipment in the vehicle in accordance with the information in the geometric profile. The vehicle further uses the driving profile for the driver to set the equipment in the vehicle in accordance with the information in the driving profile.

A geometric profile contains information regarding the equipment in the first vehicle. The information (e.g., data) in the geometric profile contains values for setting (e.g., adjusting) the equipment in the first vehicle. The geometric profile further contains information that identifies the equipment for which the values relate. For example, a geometric profile may identify the equipment as being a seat. The geometric profile may contain values for data that relates to the seat position with respect to the steering wheel or dashboard, the range of motion of the seat forward toward the dashboard and backwards away from the dashboard, the seat height, the seatback tilt, or any other physical position or range or adjustment that can be made to the seat.

A vehicle may parse the data in a geometric file to identify the equipment (e.g., seat, mirror, HVAC, steering wheel, headlights, exterior lights, speedometer, odometer, entertainment system, communication system, and so forth) that is to be adjusted. The vehicle may identify what aspect of the equipment should be set. The vehicle may then extract the value of the data from the geometric profile for the equipment and for the aspect of the operation of the equipment. The vehicle may then set that aspect of the operation of that equipment to the value specified in the geometric profile.

For example, with respect to a steering wheel, a geometric profile may identify the steering wheel and identify the aspects of the steering wheel operation that may be set. For example, the distance of the steering wheel from the dashboard and the tilt of the steering wheel may be set. So, the geometric file includes an identifier for the steering wheel, a value for the distance of the steering wheel from the dashboard, and a value for the tilt of the steering wheel. The vehicle may access the data for the steering wheel, extract the value for the distance of the steering will from the dashboard, and set the steering wheel so that the distance of the steering wheel from the dashboard is the value identified in the geometric profile.

A vehicle may include any type of electronic and/or electromechanical devices for accessing a geometric profile, extracting values from the geometric profile and setting the equipment in accordance with the values. For example, a vehicle may include a processing circuit that accesses the geometric profile, identifies the equipment referenced in the geometric profile, extracts the values of the settings for the equipment, and provides control signals to set the equipment in accordance with the value specified in the geometric profile.

In access 424, the vehicle permits the driver to access the vehicle and to operate the vehicle. Access 424 may be executed before set 422 or at the same time as set 422.

In monitor 426, the vehicle monitors the driver's adjustments to the equipment of the vehicle related to the geometric profile. Further the vehicle monitors the driver's adjustments to the vehicle equipment related to the driving profile.

An update 228, the vehicle updates the geometric profile of the driver for the vehicle and the driving profile for the driver in accordance with the information gathered in monitoring 426.

In completed 430, the vehicle determines whether the driver has completed his/her use of the vehicle. If the driver's use of the vehicle has not finished, the vehicle continues to perform monitor 426 and update 428 as long as the driver operates the vehicle. If the driver has completed use of the vehicle, control passes to changes 432.

In changes 432, the vehicle determines whether the geometric profile or the driving profile was changed during monitoring 426 and update 428. If neither of the profiles has changed, control passes to report 436. If either of the profiles has change, control passes to send 434.

In send 434, the vehicle sends the profiles that have been updated to the server.

In report 436, the vehicle reports to the server that the driver is done operating the vehicle. From report 436, control passes to end.

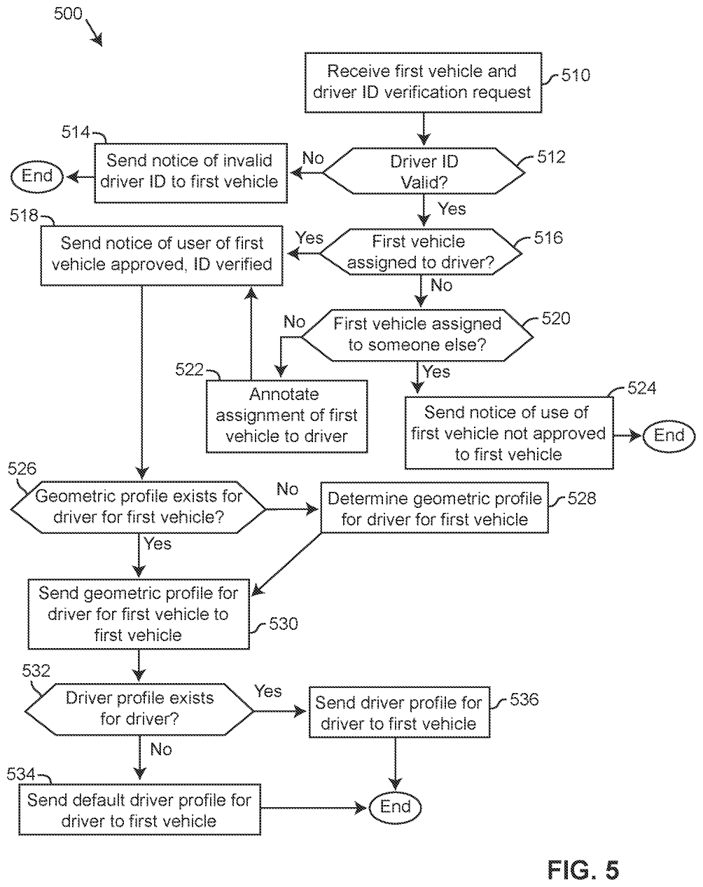

Method 500, shown in FIG. 5, is an example of a method performed by a server for managing, providing, and determining geometric and driving profiles. Method 500 includes verification request 510, valid 512, invalid 514, assigned 516, approved 518, annotate 522, another 520, not approved 524, exists 526, determined 528, send geometric 530, driving 532, send driving 534 and send default 536.

In verification request 510, the server receives a verification from a first vehicle to verify the credentials (e.g., identification) of a driver. The request includes the credentials of the driver and the identity information regarding the first vehicle.

In valid 512, the server determines whether the driver's credentials are authentic. The server may use any method for determining the authenticity of the driver's identification information. If the driver's credentials are not authentic, control moves to invalid 514. If the driver's credentials are authentic, meaning valid, control passes to assigned 516.

In invalid 514, the server sends a notice to the first vehicle that the driver's ID is invalid, so the driver is not authorized to operate the first vehicle. The first vehicle and the server, as discussed above, may communicate with each other in any manner, using any communication link, and/or using any protocol. After the server performs invalid 514, control passes to end.

In assigned 516, the server determines whether the first vehicle has been assigned to the driver for use. The server may determine whether the driver has been assigned to the first vehicle in any manner. The server may maintain any type of data, information or database to track assignments between drivers and vehicles of the fleet. If the server determines that the driver has been assigned to use the first vehicle, control passes to approved 518. If the server determines that the driver has not been assigned to use the first vehicle, control passes to another 520.

In approved 518, the server sends a notice to the first vehicle that the driver's credentials have been validated and that the driver is authorized to use the first vehicle. As discussed above, communication between the first vehicle and a server may be accomplished in any manner.

In another 520, the server determines whether the vehicle has been assigned to someone else, other than the driver requesting access, for use. If the first vehicle has been assigned to someone else for use, control passes to not approved 524. If the first vehicle has not been assigned to someone else for use, control passes to annotate 522.

In annotate 522, the server annotates its database to assign the driver the use of the first vehicle. After annotation, the data, information or database maintained by the server to track which drivers are assigned to use which vehicles shows that this driver has been assigned the first vehicle. Vehicle assignments may take into consideration assignments for a particular window during the day.

In not approved 524, the server sends a notice to the first vehicle that the driver cannot use the first vehicle. From not approved 524, control passes to end.

In exist 526, the server determines whether a geometric profile for the driver exists for the first vehicle. The server may store and access geometric profiles in any manner in any type of data structure and/or database. Geometric profiles and the information contained therein may be stored in any form and/or format (e.g., characters, ASCII, binary). If the server determines that a geometric profile for the driver exists for the first vehicle, control passes to send geometric 530. If the server determines that a geometric profile for the driver does not exist for the first vehicle, control passes to determine 528.

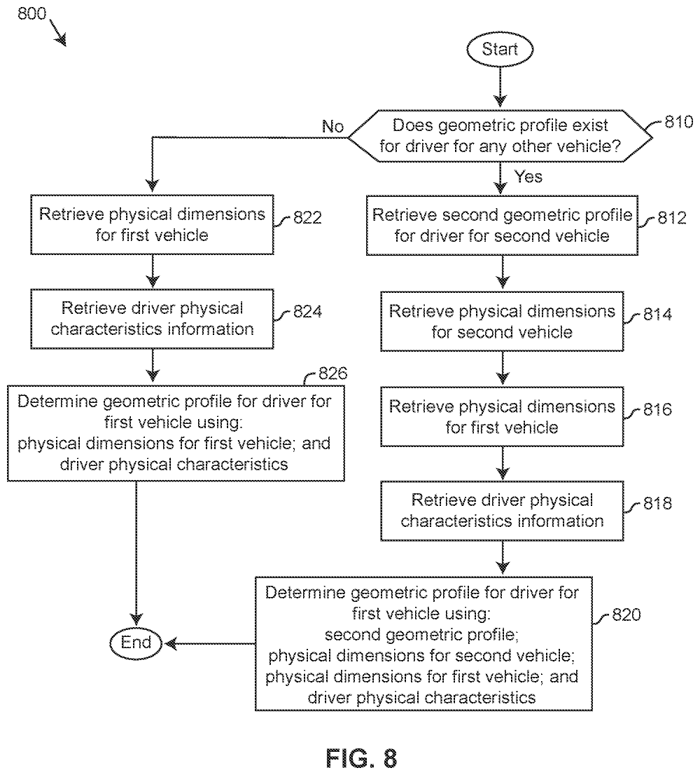

In determine 528, the server has determined that a geometric profile does not exist for the driver for the first vehicle. Absent a geometric profile for a driver for a particular vehicle, the server may determine (e.g., calculate, estimate) a geometric profile for the driver for that particular vehicle. Method 800, shown in FIG. 8, provides an example of how a server may determine a geometric profile for a driver for a particular vehicle when one does not already exist.

In send geometric 530, the server sends the geometric profile, whether it previously existed or had to be determined in determine 528, for the driver for the first vehicle to the first vehicle.

In driving 532, the server determines whether a driving profile for the driver exists. The server may store and retrieve driving profiles in any manner. If a driving profile exists, control passes to send driving 534. If a driving profile does not exist, control passes to send default 536.

In send driving 534, the server sends the driving profile for the driver to the first vehicle. From sending driving 534, control passes to end.

In send default 536, the server creates or retrieves a default driving profile for the driver. A default driving profile may contain information for setting the equipment of a vehicle to medium settings. The server sends the default driving profile for the driver to the first vehicle. Control passes to end.

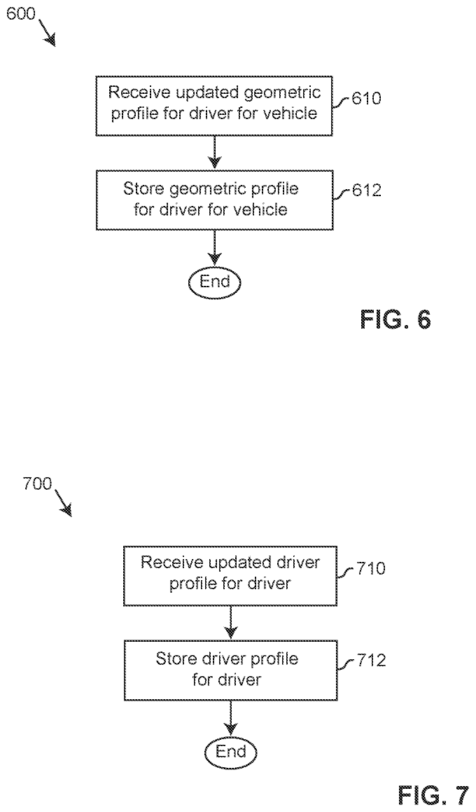

Method 600, shown in FIG. 6, is an example of a method performed by a server for receiving a geometric profile for a driver for a specific vehicle. Method 600 includes receive 610 and store 612.

In receive 610, the server receives a geometric profile from a vehicle. As discussed with respect to method 400, a vehicle will send a geometric profile to the server if the driver has made adjustments that were updated to the geometric profile for the driver for that vehicle (see monitor 426 and update 428). The server and the vehicle may communicate with each other in any manner, using any communication link and any communication protocol.

In store 612, the server stores the geometric profile received from the vehicle. When the server stores the geometric profile, the server may replace the already stored geometric profile for the driver for that vehicle. In another implementation, the server stores the received geometric profile from the vehicle as a most recent version of the geometric profile for the driver for that vehicle. After execution of store 612, control passes to end.

Method 700, shown in FIG. 7, is an example of a method performed by a server for receiving a driving profile for a driver. Method 700 includes receive 710 and store 712.

In receive 710, the server receives a driving profile from a vehicle. As discussed with respect to method 400, a vehicle will send a driving profile to the server if the driver has made adjustments that were updated into the driving profile for the driver (see monitor 426 and update 428. The server and the vehicle may communicate with each other in any manner, using any communication link and any communication protocol.

In store 712, the server stores the driving profile received from the vehicle. When the server stores the driving profile, the server may replace the already stored driving profile for the driver. In another implementation, the server stores the received driving profile from the vehicle as a most recent version of the driving profile for the driver. After execution of store 712, control passes to end.

Method 800 shown in FIG. 8, is an example of a method performed by a server for creating a geometric profile for a driver for a new vehicle that the driver has not driven before. In the description of method 800, the new vehicle that the drivers has never driven, is referred to as the first vehicle and a vehicle that the driver has already driven and for which a geometric profile already exists is referred to as the second vehicle. Method 800 includes exists 810, retrieve geometric 812, retrieve second dimensions 814, retrieve first dimensions 816, retrieve driver 818, determine 820, retrieve first dimensions 822, retrieve driver 824 and determine 826.

In exists 810, the server determines whether a geometric profile exists for the driver for any other vehicle in the fleet. If a geometric profile exists for any other vehicle, the server identifies one of those vehicles as the second vehicle. If no geometric profile exists for any other vehicles, control passes to retrieve first dimensions 822. If a geometric profile exists for at least one other vehicle, control passes to retrieve geometric 812. As discussed above, the server may store and retrieve geometric profiles in any manner and for any type of the storage system. The server may store geometric profiles in any format.

In retrieve geometric 812, the server retrieves the geometric profile of the vehicle identified as the second vehicle. As discussed above, the second vehicle is a vehicle that the driver has driven before and for which a geometric profile exists.

In retrieve second dimensions 814, the server retrieves the physical dimensions (e.g., measurements) of the second vehicle. The physical dimensions of a vehicle are discussed above. The file that stores the physical dimensions of a vehicle may be stored in any format. The dimensions stored as the physical dimensions of a vehicle may be interior and/or exterior measurements including distances, ranges and/or angles between objects related to the vehicle.

In retrieve first dimensions 816, the server retrieves the physical dimensions of the first vehicle.

In retrieve driver 818, the server retrieves the physical characteristics information of the driver. The information related to the physical characteristics of the driver may include various measurements of the bodily characteristics of the driver. The possible physical characteristics of a driver are discussed above. Any measurable physical characteristic of a driver may be in the file that stores the physical characteristics of the driver. The physical characteristics of the driver may be stored in any format.

The server may index information related to vehicles and driver in any manner for ready access and storage.

In determine 820, the server uses the second geometric profile, the second vehicle physical dimensions, the first vehicle physical dimensions and the driver physical characteristics to determine a geometric profile for the driver for the first vehicle. The server may use any process and/or mathematical formula for determining the information (e.g., values, data) for the geometric profile for the driver for the first vehicle. Any information from any file, meaning the second geometric profile, the second vehicle physical dimensions, the first vehicle physical dimensions and the driver physical characteristics, may be used in any manner to determine the values of the information for the geometric profile for the driver for the first vehicle. The server may use the information to determine lengths, distances, angles, orientations, heights, depths, areas, volumes, temperatures, or any other physical quantity and/or quality to prepare the geometric profile for the driver for the first vehicle. In an implementation, machine learning is used to interpret the information from the second geometric profile, the second vehicle physical dimensions, the first vehicle physical dimensions, and the driver physical characteristics to determine the information for the geometric profile for the driver for the first vehicle. After determine 820 is performed, control passes to end.

Retrieve first dimensions 822 is the same as retrieve first dimensions 816.

Retrieve driver 824 is the same as retrieve driver 818.

In determine 826, the server determines a geometric profile for the driver for the first vehicle when there is no geometric profile for any other vehicle in the fleet. The server uses the first vehicle physical dimensions and the driver physical characteristics, as discussed above with respect to determine 820, to determine the geometric profile for the driver for the first vehicle. Because determine 826 has access to less data then determine 820, some of the formulas used in determining 826 may be simplified versions of the formulas used in determine 820. After determine 826 is performed, control passes to end.

The foregoing description discusses implementations (e.g., embodiments), which may be changed or modified without departing from the scope of the present disclosure as defined in the claims. Examples listed in parentheses may be used in the alternative or in any practical combination. As used in the specification and claims, the words ‘comprising’, ‘comprises’, ‘including’, ‘includes’, ‘having’, and ‘has’ introduce an open-ended statement of component structures and/or functions. In the specification and claims, the words ‘a’ and ‘an’ are used as indefinite articles meaning ‘one or more’. While for the sake of clarity of description, several specific embodiments have been described, the scope of the invention is intended to be measured by the claims as set forth below. In the claims, the term “provided” is used to definitively identify an object that is not a claimed element but an object that performs the function of a workpiece. For example, in the claim “an apparatus for aiming a provided barrel, the apparatus comprising: a housing, the barrel positioned in the housing”, the barrel is not a claimed element of the apparatus, but an object that cooperates with the “housing” of the “apparatus” by being positioned in the “housing”.

The location indicators “herein”, “hereunder”, “above”, “below”, or other word that refer to a location, whether specific or general, in the specification shall be construed to refer to any location in the specification whether the location is before or after the location indicator.

Methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods.

What is claimed is:

1. An electric vehicle comprising:
at least one video camera, the at least one video camera oriented to capture images rearward of the electric vehicle;
at least one display configured to present the images captured by the at least one video camera, the at least one display positioned in a front of the electric vehicle and visible to an operator of the electric vehicle while the operator is facing forward with respect to the electric vehicle;
a rear wheel module positioned at a rear of the electric vehicle, the rear wheel module includes a first wheel and a second wheel;
a front wheel module positioned at a front of the electric vehicle, the front wheel module includes a third wheel and a fourth wheel; and
a steering wheel; wherein:
the rear wheel module operates in a powering and a steering mode;
the first wheel and the second wheel rotate to move the electric vehicle in a direction of travel rearward of the electric vehicle, whereby the first wheel and the second wheel are positioned forward of the third wheel and the fourth wheel with respect to the direction of travel;
the front wheel module operates in a locked and a freewheeling mode;
the steering wheel turns the first wheel and the second wheel, but not the third wheel and the fourth wheel;
a clockwise rotation of the steering wheel causes the electric vehicle to turn to a rightward with respect to the direction of travel and with respect with the images captured by the at least one video camera and presented on the at least one display; and
a counterclockwise rotation of the steering wheel causes the electric vehicle to turn to a leftward with respect to the direction of travel and with respect with the images captured by the at least one video camera and presented on the at least one display.

2. The electric vehicle of claim 1, wherein a tilt of the steering wheel is set in accordance with a geometric profile specific to the operator and the electric vehicle.

3. The electric vehicle of claim 1, further comprising a seat, wherein the seat is positioned in accordance with a geometric profile specific to the operator and the electric vehicle whereby the seat is positioned to position an eyes of the operator with respect to the at least one display.

4. The electric vehicle of claim 1, further comprising a seat, wherein the seat is positioned in accordance with a geometric profile specific to the operator and the electric vehicle to position a back of the seat with respect to the steering wheel.

5. The electric vehicle of claim 1, wherein a responsiveness of the steering wheel is set in accordance with a driver preference specific to the operator.

6. The electric vehicle of claim 1, further comprising a seat and two or more pedals, wherein the seat is positioned in accordance with a geometric profile specific to the operator and the electric vehicle whereby the seat is positioned to position the operator with respect to the two or more pedals and the steering wheel.

7. The electric vehicle of claim 1, wherein the front wheel module further operates in a locked and powering mode, whereby the third wheel and the fourth wheel also move the electric vehicle in the direction of travel rearward of the electric vehicle.

8. An electric vehicle comprising:
a video camera oriented to capture images rearward of the electric vehicle;
a display configured to present the images captured by the video camera, the display positioned in a front of the electric vehicle and visible to an operator of the electric vehicle while the operator is facing forward with respect to the electric vehicle;
a rear wheel module positioned at a rear of the electric vehicle, the rear wheel module includes a first wheel and a second wheel;
a front wheel module positioned at a front of the electric vehicle, the front wheel module includes a third wheel and a fourth wheel; and
a steering wheel; wherein:
the first wheel and the second wheel rotate to move the electric vehicle in a direction of travel rearward of the electric vehicle, whereby while traveling in the direction of travel, the first wheel and the second wheel are positioned forward of the third wheel and the fourth wheel in the direction of travel;
the steering wheel turns the first wheel and the second wheel, but not the third wheel and the fourth wheel;
a clockwise rotation of the steering wheel causes the electric vehicle to turn to a rightward direction with respect to the direction of travel and with respect with the images captured by the video camera and presented on the display; and
a counterclockwise rotation of the steering wheel causes the electric vehicle to turn to a leftward direction with respect to the direction of travel and with respect with the images captured by the video camera and presented on the display.

9. The electric vehicle of claim 8 wherein a tilt of the steering wheel is set in accordance with a geometric profile specific to the operator and the electric vehicle.

10. The electric vehicle of claim 8, wherein a responsiveness of the steering wheel is set in accordance with a driver preference specific to the operator.

11. The electric vehicle of claim 8, wherein the third wheel and the fourth wheel rotate to move the electric vehicle in the direction of travel.

12. An electric vehicle comprising:
at least one video camera oriented to capture images rearward of the electric vehicle;
at least one display configured to present the images captured by the at least one video camera, the at least one display positioned in a front of the electric vehicle and visible to an operator of the electric vehicle while the operator is facing forward with respect to the electric vehicle;
a rear wheel module positioned at a rear of the electric vehicle, the rear wheel module comprising a first wheel and a second wheel;
a front wheel module positioned at a front of the electric vehicle, the front wheel module comprising a third wheel and a fourth wheel; and
a steering wheel; wherein:
one of the front wheel module or rear wheel module rotate to move the electric vehicle in a direction of travel rearward of the electric vehicle;
the steering wheel turns one of the first wheel and the second wheel of the rear wheel module or the third wheel and the fourth wheel of the rear wheel module;
a clockwise rotation of the steering wheel causes the electric vehicle to turn to a rightward with respect to the direction of travel and with respect with the images captured by the at least one video camera and presented on the at least one display; and
a counterclockwise rotation of the steering wheel causes the electric vehicle to turn to a leftward with respect to the direction of travel and with respect with the images captured by the at least one video camera and presented on the at least one display.
